(19) United States
(12) Patent Application Publication
(10) Pub. No.: US 2017/0206612 A1
(43) Pub. Date: Jul. 20, 2017

(54) SOCIAL MEDIA SAFE MODE FOR COMMUNICATIONS

(71) Applicant: International Business Machines Corporation, Armonk, NY (US)

(72) Inventors: Marco A. Benavides, Carrollton, TX (US); Joshua A. Cheng, Grand Prairie, TX (US); Tsz S. Cheng, Grand Prairie, TX (US); Stephanie De La Fuente, Dallas, TX (US)

(21) Appl. No.: 14/997,197

(22) Filed: Jan. 15, 2016

(51) Int. Cl. G06Q 50/00; G06Q 30/02; H04L 29/08

(52) U.S. Cl. CPC G06Q 50/01; H04L 67/10; G06Q 30/0201

(57) ABSTRACT

Communicating posts in a social media network safe mode (SMNSM) may include receiving, by a processor, post entries each having selected permissions in the SMNSM on a social media network. The processor analyzes sentiment of the post entries to detect potential harm or embarrassment. The processor selectively displays post entry trends and categorizes the sentiment of the post entries or reply post entries. A safety alert is sent to a creator for negative categorized post entries. The processor selectively forwards the post entries to a selected reviewer, and selectively forwards a feedback communication from the reviewer to the creator. The processor selectively publishes the post entries. Unpublished post entries are viewable by the creator. Post entries selected for publishing are displayed in an initial intended post space, and the selected post entries for publishing are one of immediately posted or selectively delayed for publishing.

### BACKGROUND

Personal journals are used to document daily lives freely, privately and comfortably with high level of privacy. Today, people regularly use social media networks (SMNs) to share thoughts/feelings and socialize with friends and family. Since it may be cumbersome to maintain both personal journaling and sharing on SMN, some people may choose (sometimes subconsciously) to use SMNs as a form of personal journaling. With SMNs' high usage, however, there have been high profile cases where people were terminated/disciplined by schools, fired from their jobs or were embarrassed due to postings and/or activities deemed inappropriate to others (e.g., user A may post an inappropriate comment on a controversial social issue, user B seeing an inappropriate video may appear as an activity, etc.). Naturally, some people are very concerned about explicit/implicit posting on SMNs due to the privacy issues and/or human mistakes.

### SUMMARY

Embodiments of the invention relate to controlling dissemination of social media postings. One embodiment includes a computer program product for communicating posts in a social media network safe mode (SMNSM), the computer program product comprising a computer readable storage medium having program instructions embodied therewith, the program instructions executable by a processor to cause the processor to: receive, by the processor, one or more post entries each having at least one of a private permission and a public permission in the SMNSM on a social media network. Each post entry includes a time-stamp for creation time and date. The processor analyzes sentiment of the one or more post entries to detect potential harm or embarrassment to a creator. The processor additionally selectively displays post entry trends including at least one of: volume of reply post entries submitted over time, and mood or sentiment trend over time. The processor further categorizes the sentiment of the one or more post entries or reply post entries into positive, negative and neutral sentiment, wherein a safety alert is sent to the creator for negative categorized post entries. The processor also selectively forwards the one or more post entries to a selected reviewer, and selectively forwards a feedback communication from the reviewer to the creator of the one or more post entries. The feedback communication includes at least one of approval, disapproval, edits or comments for the one or more post entries. The processor additionally selectively publishes the one or more post entries. Unpublished post entries are viewable by the creator, and one or more post entries selected for publishing are displayed in an initial intended post space for at least one of a general feed, a comment on a photo, video or graphic, and another post, and the selected one or more post entries for publishing are one of immediately posted or selectively delayed for publishing. The categorized sentiment for the one or more private post entries are selectively used for: targeted offer serving, product reviews and feedback by organizations.

These and other features, aspects and advantages of the present invention will become understood with reference to the following description, appended claims and accompanying figures.

### BRIEF DESCRIPTION OF THE DRAWINGS

FIG. 1 depicts a cloud computing environment, according to an embodiment;

FIG. 2 depicts a set of abstraction model layers, according to an embodiment;

FIG. 3 is an example context flow for postings on a social media network, according to an embodiment of the present invention;

FIG. 4 shows an example use case for social media network safe mode (SMNSM), according to an embodiment;

FIGS. 5A-C show examples of multiple views for SMNSM, according to an embodiment;

FIG. 6 shows an example interface for providing bulk publishing of unpublished post entries, according to an embodiment;

FIG. 7 shows an example dashboard interface for viewing SNMSM posts for multiple types of social media network users, according to an embodiment; and

FIG. 8 illustrates a block diagram for a process for communicating posts in a SMNSM, according to one embodiment.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As some people are hesitant to post on a social media network (SMN) (e.g., an organizational social network, FACEBOOK®, INSTAGRAM®, TWITTER®, etc.) due to the privacy and confidence issues, both quantity and quality (e.g., reflecting of one's true feelings, etc.) of posts are affected. As a result, the scope and results of sentiment analysis of such data are also effected for the purposes of marketing, mental health, self-improvement, etc. For example, topics relating to mental health issues, products potentially embarrassing in nature, and/or domestic abuse are discussed with less frequency due to their inherently private nature. This tends to lead to insufficient quantity and quality of private data to conduct sentiment analysis. The lack of sentiment analysis of private data severely limits the insight gathered by marketers, mental health professionals, public safety officials, etc.

One or more embodiments provide a SMNSM to users of an SMN—including the ability to freely record daily events, thoughts, and activities on SMNs while safe guarding users from an unintended negative online presence. In one embodiment, the system allows SMN users to record their thoughts on SMNs in the same manner they are currently able to: in response to another user's post (images, videos, shared articles, events); in response to their own post (images, videos, shared articles, events); by sharing videos viewed, articles read, posts liked; a new post (e.g., “What is on your mind?”); sharing content (images, videos, shared articles, events), etc., but provides the safety of having posts reviewed before publishing, allows viewing without publishing, provides for sentiment analysis prior to publishing, etc., as described below.

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service Models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

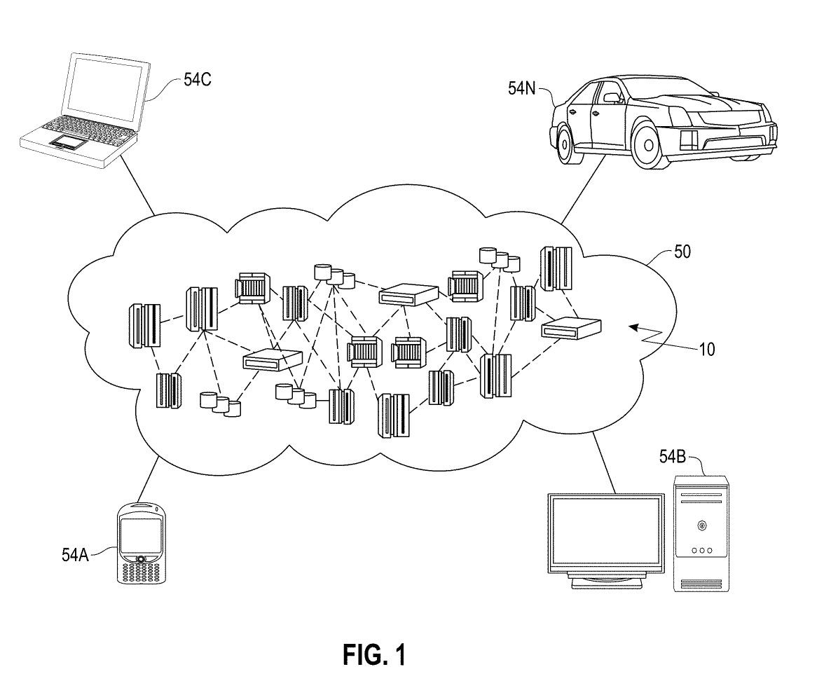

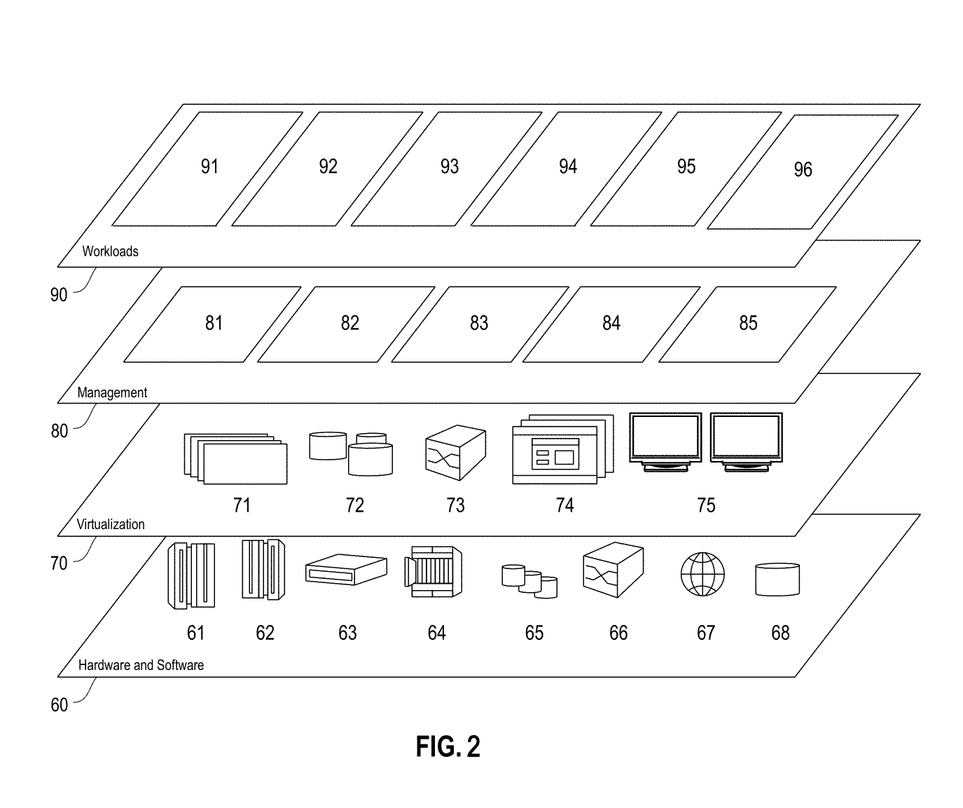

Referring now to FIG. 1, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows the cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

Referring now to FIG. 2, a set of functional abstraction layers provided by the cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, a management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment and billing or invoicing for consumption of these resources. In one example, these resources may comprise application software licenses. Security provides identity verification for cloud consumers and tasks as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95 and communicating and controlling posts in a SMNSM 96. As mentioned above, all of the foregoing examples described with respect to FIG. 2 are illustrative only, and the invention is not limited to these examples.

It is understood all functions of one or more embodiments as described herein may be typically performed in the computing environment 50 (FIG. 1), which can be tangibly embodied as hardware processors and with modules of program code. However, this need not be the case. Rather, the functionality recited herein could be carried out/implemented and/or enabled by any of the layers 60, 70, 80 and 90 shown in FIG. 2.

It is reiterated that although this disclosure includes a detailed description on cloud computing, implementation of the teachings recited herein are not limited to a cloud computing environment. Rather, the embodiments of the present invention may be implemented with any type of clustered computing environment now known or later developed.

In one embodiment, the SMNSM system (e.g., a cloud computing node 10 of the cloud computing environment 50, a server computing system, etc.) safeguards a user's online presence by controlling the prevention of the user's posts and/or activities to be immediately published and visible to others by default of the post. The posts/activities are kept in private view by default when the SMNSM setting is enabled by the user. After the posts/activities are placed in private view, the user is then given the option to publish the posts at a later time. When a post (or an activity) is created, the user is given several options, such as take no action and allow the post to only be viewed privately by the use, allow the post be publicly visible at a later date, and request peer users to review/edit the post prior to allowing it to become publicly visible. While the post is being reviewed by the elected peer user, the SMNSM system prevents the user from publishing the post until the post is either edited or approved by the peer reviewer. Edits to the post or feedback provided by a peer reviewer is sent back to the user for review. Posts approved by the selected peers then become available for publishing by the user. The SMNSM system also provides users an interface to view unpublished posts. If the user decides the posts are relevant for public view, the unpublished posts may be published immediately. In one embodiment, the SMNSM system analyzes posts for sentiment analysis—alerting the user if negative sentiment is detected in the post. Selected peer reviewers are also alerted if the system detects: a high volume of posts containing negative sentiment, the user is at risk for causing harm to himself/herself or others, and phrases or keywords of concern in the user's post.

In one embodiment, the SMNSM system provides for a user to write freely and privately on a SMN (as it were a private journal), and yet provides to control him/her to publish/make publicly visible those private or uncomfortable posts/comments at later time on the SMN. The SMNSM system eliminates the confusion and/or fear behind the privacy settings currently provide by social media networks. The SMNSM system provides the user the ability to freely document daily activities, thoughts, and comments on existing social media networks with confidence, allowing the social media network to function as a private journal. The sense of security provided by our system can increase the wealth of private thoughts and feelings posted by the user on the SMNs. Previously undocumented private thoughts can be used by social media networks for the purposes of: marketing, user segmentation, counseling, law enforcement, mental health, public safety, user self-improvement, prevent the user from unintentionally presenting a negative online presence due to the immediate publishing of comments, in the heat of the moment. In one or more embodiments, the SMNSM system provides the user a window of time to reconsider the contents of the post—a cooling off period. Posts kept in private view and those reviewed by SMN peers are maintained in the system with the original timestamp recorded at the time of creation of the post—allowing a view into users' past thoughts and feelings. The ability to publish private posts with the original date/time and thread location of the post provides relevance when analyzing SMN threads. Private posts can contain information inappropriate for a given time or situation. One or more embodiments provides the user a platform to initially record the otherwise improper thoughts, which can be made public at a time when the user feels comfortable.

In one or more embodiments, the SMNSM system provides and enhances the current capabilities of social media networks by controlling the ability to reclassify posts from existing as privately available to existing publicly, without requiring the user to repost the entry. The SMNSM system analyzes the sentiment of the posts to detect potential harm or embarrassment that the user may do to him/herself or others, preventing physical harm or bullying. The sentiment analysis can also be used by marketing teams for targeted offer serving. The social sentiment analysis may be mined for product reviews and feedback by manufacturers, consumer goods companies, retailers, financial institutions, etc. This information is often omitted due to the fear of exposing one's opinion publicly. Providing control of private posts enables the user to share this information that would otherwise be kept private for further mining.

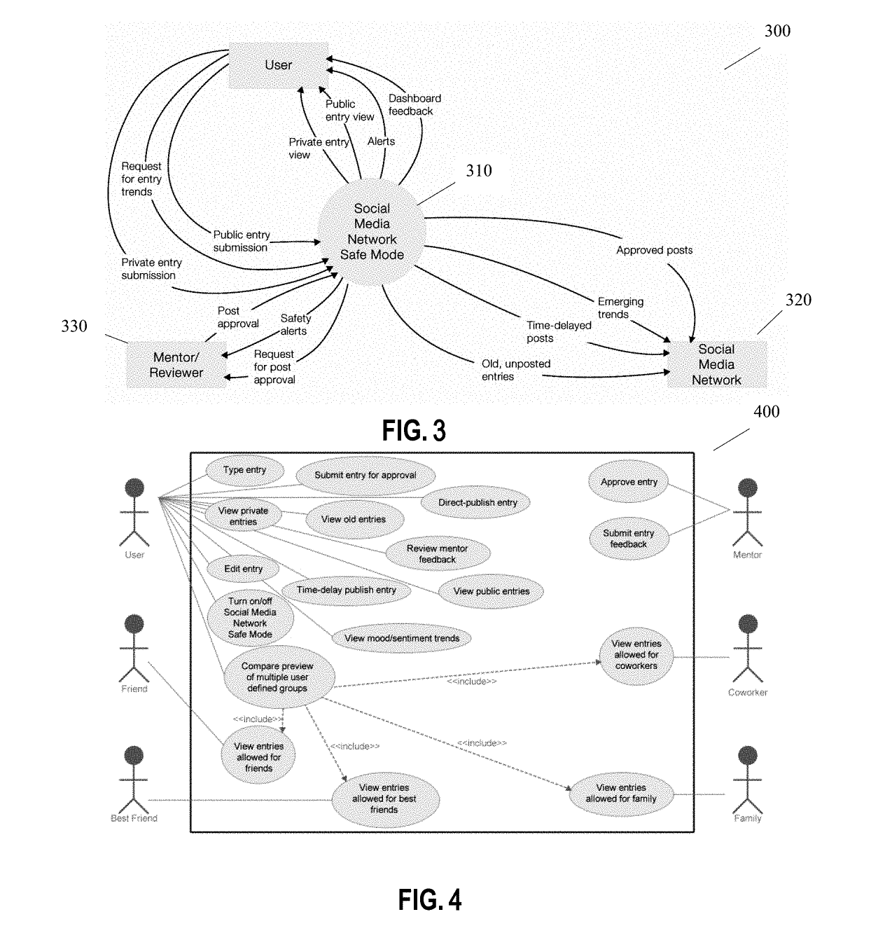

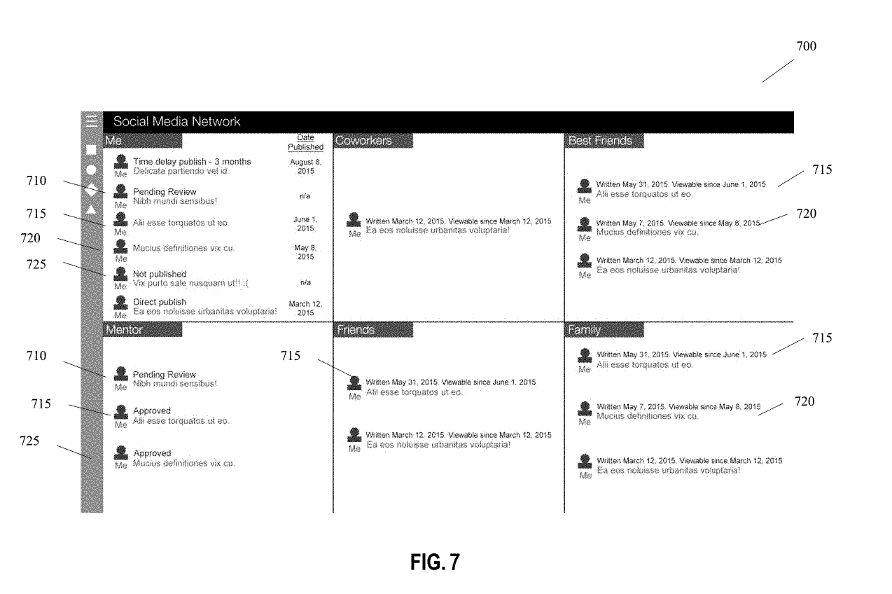

FIG. 3 is an example context flow 300 for postings on a social media network, according to an embodiment of the present invention. In one embodiment, the context flow 300 includes the SMNSM 310, SMN 320, mentor/reviewer 330 and a user that creates private and public posts. In one embodiment, the user can submit public and/or private entries for submission to the SMN 320 via the SMNSM 310. The user can also request to view entry trends. An example of entry trends may be the volume of posts submitted over time or mood/sentiment trends over time. The user can also get dashboard 700 (FIG. 7) feedback via the SMNSM 310. Feedback may include entry trends (mood/sentiment trends, posting volume trends, etc.). Alerts may be sent to the user in the case that the SMNSM 310 sentiment analysis categorizes a certain number of negative posts. The mentor/reviewer 330 can receive a request to approve a post created by a user or mentee. The mentor/reviewer 330 can make direct edits to the post or suggest feedback, which would then be submitted back to the user or mentee. In the case that the SMNSM 310 sentiment analysis categorizes a certain number of negative posts, a safety alert can be sent to the mentor to prevent any possible harmful behavior the user may cause to himself/herself. The approved posts, entry trends, time-delayed posts, and private entries can be posted to the social media network.

FIG. 4 shows an example use case 400 for SMNSM, according to an embodiment. In one embodiment, the user may create a post or entry on a SMN. The user can also submit the entry to be approved by a mentor/reviewer prior to publishing on the SMN. After the mentor/reviewer has supplied feedback, the user can review the feedback. The user can view both unpublished (private) and published (public) entries, and these can be edited by the user. The user can publish an entry instantly or specify a date/time for future publishing. Entry trends, such as mood or sentiment trends, can then be shown to the user as feedback. The mentor can approve entries assigned to him/her by a mentee and submit feedback on the entry.

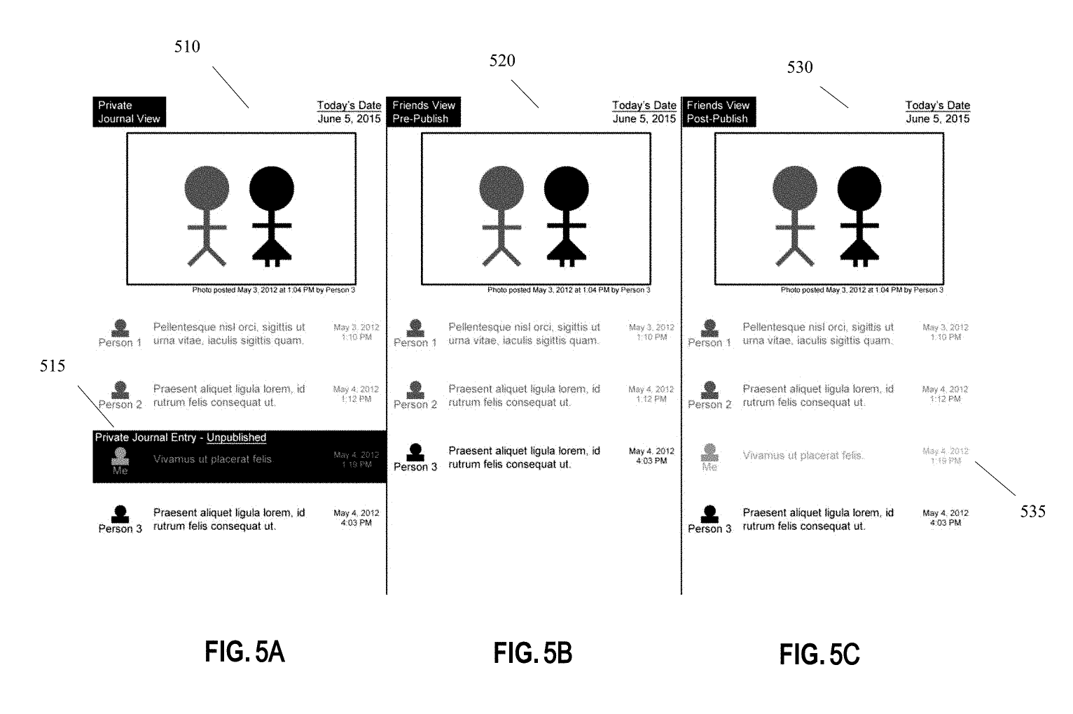

FIGS. 5A-C show examples of multiple views for SMNSM, according to an embodiment. Different user types such as friends, best friends, coworkers, and families may view entries allowed for their user types. The primary user (“Me”) can use a dashboard 700 (FIG. 7) to compare the different views of these user types. The user can create a post on an SMN, and if the user opts to keep the post private, the intended location of the post is recorded. FIG. 5A shows an example display interface 510 showing a private journal view. In the example display interface 510, “Me” generated a private journal entry 515 that is unpublished. Posts from users “Person 1,” “Person 2” and “Person 3” are shown. In the example case of the private journal entry 515, the private entry was created on May 4, 2012 at 1:19 PM.

In one embodiment, FIG. 5B shows an example display interface 520 showing a friend's view for pre-publish of the private journal entry 515. The example display interface 520 shows what users see after the primary user “Me” has opted to keep his/her post private. If the primary user “Me” ever publishes the private journal entry 515, it would be placed in its initial creation spot using its initial timestamp. For example, FIG. 5C shows the example display interface 530 displaying the “Me” post 535 located in a position according to its initial creation spot and timestamp. Because its timestamp is May 4, 2012 at 1:19 PM, it was placed after the post created at 1:12 PM but before the post created at 4:03 PM on the same date.

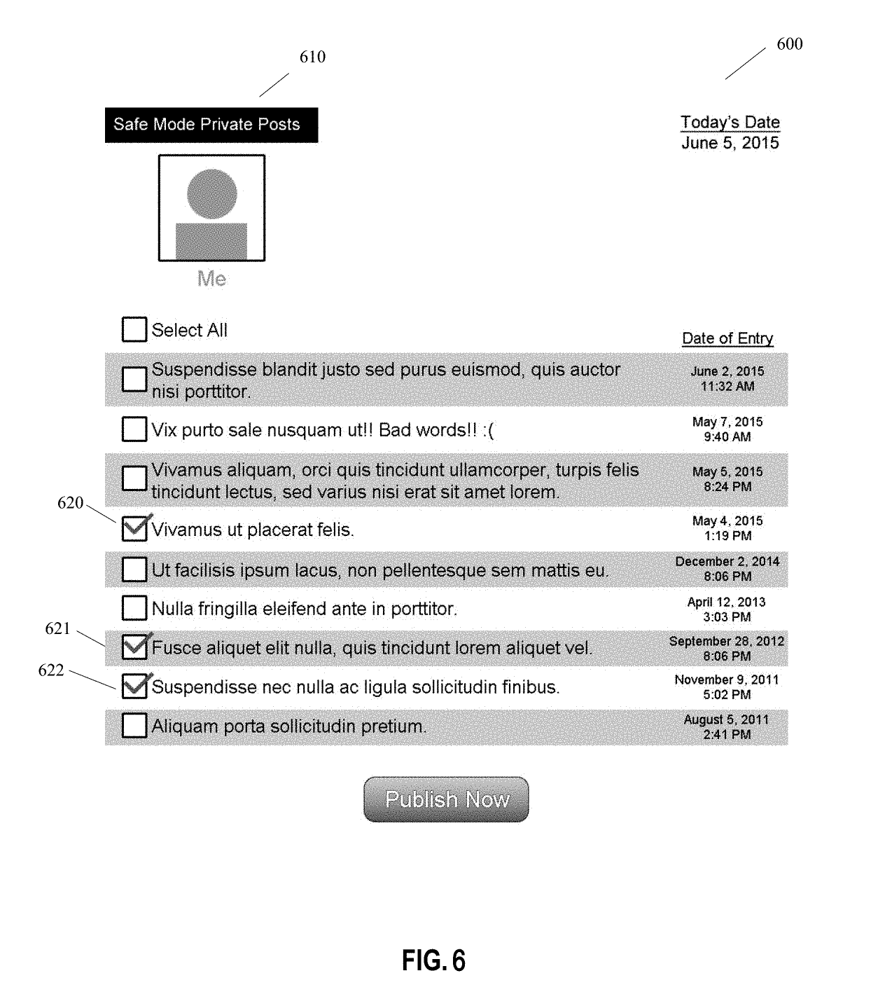

FIG. 6 shows an example interface 600 for providing bulk publishing of unpublished post entries, according to an embodiment. In the example interface 600, safe mode posts 610 are listed and may be selected for publishing by selecting (e.g., clicking using a pointer device, speaking commands, etc.) the various private posts. The user is able to view his/her unpublished entries using the example interface 600. The individual entries include a timestamp of creation of the entry. Because entries may have been made in the past, some entries may have timestamps from previous years. The user may publish any number of entries from this example interface 600. The user can also choose to “Select All” and publish all private entries. When the user opts to publish a private entry, it would appear in its initial intended space. This could be in a general feed of a SMN, or as a comment on a posted photo, for example. In the example interface 600, a selection is made for private posts 620, 621 and 622. The user would then select “Publish Now” too make the private posts published.

FIG. 7 shows an example dashboard 700 interface for viewing SNMSM posts for multiple types of SMN users, according to an embodiment. In the example dashboard 700, primary user “Me” may view posts for other selective users, such as coworkers, best friends, mentor, friends, and family. In one example, primary user “Me” has a pending review post 710, a mentor/reviewer approved posts 715 and 720, and a post that has yet to be published 725. The dashboard shows the other selective users view of the primary user “Me” post entries. The primary user “Me” is able to view the example dashboard 700 to compare the different views of different user types. The user's private view may include labels indicating the type of publishing that was selected for the entry. For example: the user may have created an entry for publishing at a date in the future. In the case that the user must have the entry reviewed, the user can select a mentor/reviewer. Different mentors can be selected for different entries, and this can be useful in career/professional types of SMNs. The user may also choose to keep entries unpublished. In this example, unpublished entries are not visible to users outside of the primary user “Me.” Entries can remain unpublished indefinitely, or they can be manually published at a later date/time.

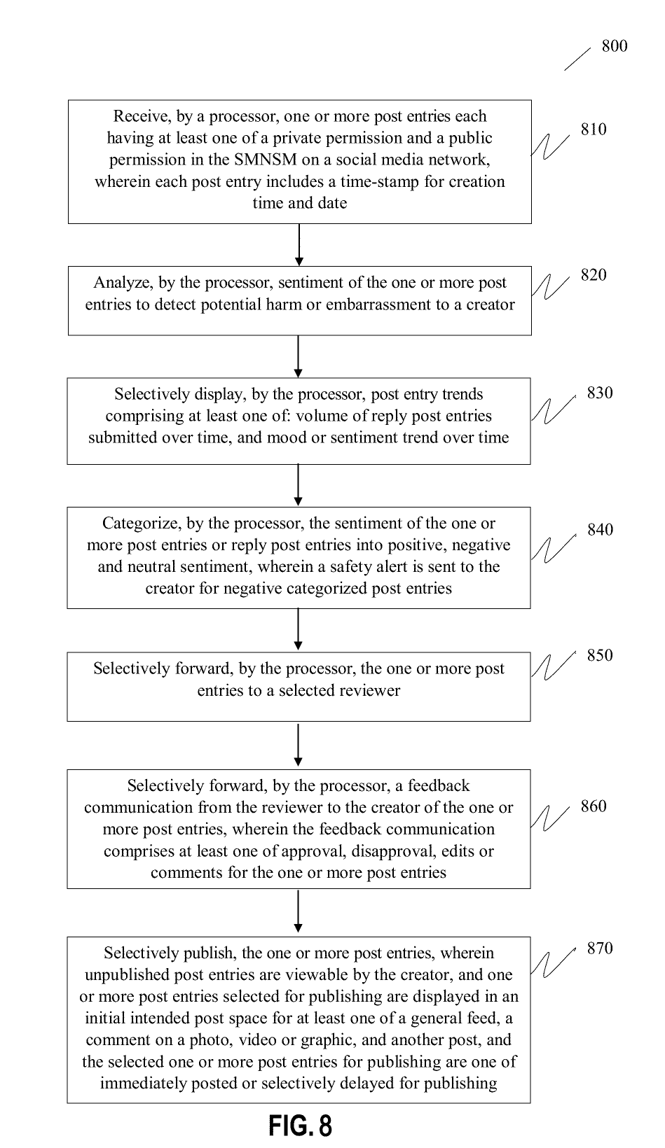

FIG. 8 illustrates a block diagram for a process 800 for communicating posts in a SMNSM, according to one embodiment. In block 810, a processor (e.g., a processor of a computing node 10, FIG. 1) receives one or more post entries each having at least one of a private permission (only viewable by a primary user and not published) and a public permission (e.g., published directly) in the SMNSM on a SMN. Each post entry includes a time-stamp for creation time and date. In block 820 the processor analyzes sentiment of the one or more post entries to detect potential harm or embarrassment to a creator (e.g., using a sentiment analyzer that searches post text for positive, neutral and negative sentiment). In block 830 the processor selectively displays post entry trends including at least one of: volume of reply post entries submitted over time, and mood or sentiment trend over time. In block 840 the processor categorizes the sentiment of the one or more post entries or reply post entries into positive, negative and neutral sentiment. A safety alert is sent to the creator for negative categorized post entries. In block 850 the processor selectively forwards the one or more post entries to a selected reviewer/mentor. In block 860 the processor selectively forwards a feedback communication from the reviewer to the creator of the one or more post entries. The feedback communication includes at least one of approval, disapproval, edits or comments for the one or more post entries. In block 870, the one or more post entries are selectively published. Unpublished post entries are viewable by the creator, and one or more post entries selected for publishing are displayed in an initial intended post space for at least one of a general feed, a comment on a photo, video or graphic, and another post, and the selected one or more post entries for publishing are one of immediately posted or selectively delayed for publishing. The categorized sentiment for the one or more private post entries are selectively used for targeted offer serving, product reviews; and feedback by organizations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product for communicating posts in a social media network safe mode (SMNSM), the computer program product comprising a computer readable storage medium having program instructions embodied therewith, the program instructions executable by a processor to cause the processor to:
receive, by the processor, one or more post entries each having at least one of a private permission and a public permission in the SMNSM on a social media network, wherein each post entry includes a time-stamp for creation time and date;
analyze, by the processor, sentiment of the one or more post entries to detect potential harm or embarrassment to a creator;
selectively display, by the processor, post entry trends comprising at least one of: volume of reply post entries submitted over time, and mood or sentiment trend over time;
categorize, by the processor, the sentiment of the one or more post entries or reply post entries into positive, negative and neutral sentiment, wherein a safety alert is sent to the creator for negative categorized post entries;
selectively forward, by the processor, the one or more post entries to a selected reviewer;
selectively forward, by the processor, a feedback communication from the reviewer to the creator of the one or more post entries, wherein the feedback communication comprises at least one of approval, disapproval, edits or comments for the one or more post entries; and
selectively publish, the one or more post entries, wherein unpublished post entries are viewable by the creator, and one or more post entries selected for publishing are displayed in an initial intended post space for at least one of a general feed, a comment on a photo, video or graphic, and another post, and the selected one or more post entries for publishing are one of immediately posted or selectively delayed for publishing,
wherein the categorized sentiment for the one or more private post entries are selectively used for:
targeted offer serving;
product reviews; and
feedback by organizations.
